(19) United States
(12) Patent Application Publication
(10) Pub. No.: US 2017/0140003 A1
(43) Pub. Date: May 18, 2017

(54) METHOD FOR CREATING INDIVIDUAL USER PROFILE, ELECTRONIC DEVICE, AND NON-TRANSITORY COMPUTER-READABLE STORAGE MEDIUM

(71) Applicants: LE HOLDINGS (BEIJING) CO., LTD., Beijing (CN); LECLOUD COMPUTING CO., LTD., Beijing (CN)

(72) Inventor: Youming Zhang, Beijing (CN)

(21) Appl. No.: 15/248,637

(22) Filed: Aug. 26, 2016

Related U.S. Application Data
(63) Continuation of application No. PCT/CN2016/083248, filed on May 25, 2016.

(30) Foreign Application Priority Data
Nov. 12, 2015 (CN) 201510777008.3

(51) Int. Cl. G06F 17/30

(52) U.S. Cl. CPC G06F 17/30528

(57) ABSTRACT

Disclosed are techniques for creating individual user profile, including: detecting behaviors of a user and assigning the user with various labels; determining a reference value of each attribute derived from each label based on the number and/or timeliness of a label assigned to the user within a period, an attribute derived from each label using the rules of derivation and the logical strength values of the rules of derivation; comparing the reference value of one of the attributes derived from each label with a predetermined threshold to judge whether or not it can be determined that the user attributes include the one of the attributes, determining, if not, it is judged whether it can be determined that the user attributes include the one of the attributes using the reference value as well as reference values of the attribute under other labels; and completing a user profile.

### CROSS REFERENCE TO RELATED APPLICATIONS

This application is a continuation of International Application No. PCT/CN 2016/083248, filed on May 25, 2016, which is based upon and claims priority to Chinese Patent Application No. 201510777008.3, filed on Nov. 12, 2015, the entireties of each are incorporated herein by reference.

### TECHNICAL FIELD

The disclosure relates to the technical field of user profiles and, more particularly, to creating individual user profiles and an electronic device.

### BACKGROUND

As the Internet has gradually stepped into the era of big data, all behaviors of consumers will be “visualized” for enterprises. As a result, the enterprises are focusing on how to use big data to provide accurate services to users. Thus, the concept of a “user profile” is often considered.

A user profile, namely, labeled user information, is a panoramic commercial picture perfectly abstracted for a user after enterprises collect and analyze main information, such as social attributes, habits, and behaviors of the user. The user profile provides a sufficient information base for the enterprises to help them quickly find accurate user groups, as well as more extensive feedback information, such as user demands. In the field of user profiles, attributes are the dimensions required for statistical analysis in user profiling, such as male and female in gender, juvenile, youth, middle age and old age, and various levels or categories of income.

Two main methods for user profiling are conventionally utilized. In a first method, a user profile is directly drawn based on user registration information. In the second method, behaviors of a user are first detected, and the user is then labeled with various labels. Finally, the personal experience is utilized to analyze the labels, thereby deriving a user profile.

However, the first method has disadvantages in that currently, access of many websites/media does not require registration in advance, so these websites/media are not clear about the attributes of users. In addition, some users are reluctant to register user information. And even if the users register information, it is difficult to ensure the accuracy of registered information (for example, information related to user privacy, time factors, and the like). Thus, it is difficult to obtain an accurate user profile.

The second method has disadvantages in that the obtained user profiles may differ greatly due to excessive dependence on individual factors of the background staff. Furthermore, interference of noise labels to the user profiles is hard to avoid, and the label timeliness is not taken into consideration. As a result, the obtained user profiles are not accurate enough.

### SUMMARY

The application provides a method for creating individual user profile and an electronic device to solve the technical problem of inaccuracy of user profiling.

An embodiment of the present application provides a method for creating an individual user profile. The method includes: detecting behaviors of a user based on a label rule library including labels, attributes, rules of derivation between labels and the attributes, and logical strength values of the derivation rules to determine user attributes. This may include detecting behaviors of the user and assigning the user with various labels; determining a reference value of each attribute derived from each label based on a number and/or timeliness of a label assigned to the user in a period, an attribute derived from each label using the rules of derivation and the logical strength values of the rules of derivation; comparing the reference value of one of the attributes derived from each label with a predetermined threshold to judge whether it can be determined that the user attributes include the above attribute. If not, then whether the user attributes include the above attribute is determined by use of the reference value as well as reference values of the attribute under other labels; and completing a user profile based on the determined user attributes.

Another embodiment of the present application provides an electronic device. The electronic device includes: at least one processor; and a memory communicably connected with the at least one processor for storing instructions executable by the at least one processor, wherein execution of the instructions by the at least one processor causes the at least one processor to execute the method for creating individual user profile mentioned above.

Yet another embodiment of the present application provides a non-transitory computer-readable storage medium storing executable instructions that, when executed by an electronic device, cause one or more processors associated with the electronic device to execute the method for creating the individual user profile mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flow chart of a method for creating individual user profile according to an embodiment of the disclosure;

FIG. 2 shows a detailed execution chart of a preferred embodiment of step S103 of the method for creating individual user profile shown in FIG. 1;

FIG. 3 is a schematic view showing a structure of a system for creating individual user profile according to an embodiment of the disclosure;

FIG. 4 shows an architecture for implementing the method and system for creating individual user profile according to the embodiments of the disclosure; and

FIG. 5 shows a schematic structure for an electronic device or server for implementing the embodiments of the disclosure.

### DETAILED DESCRIPTION

To make the objectives, technical solutions, and advantages of the embodiments of the disclosure more clear, the following will clearly and completely describe the embodiments of the disclosure with reference to the drawings. Obviously, the described embodiments are merely part of the embodiments of the disclosure, but do not encompass all possible embodiments. Based on the description provided in the disclosure, other embodiments obtained by the ordinary skill in the art without undue experimentation fall within the scope of the disclosure.

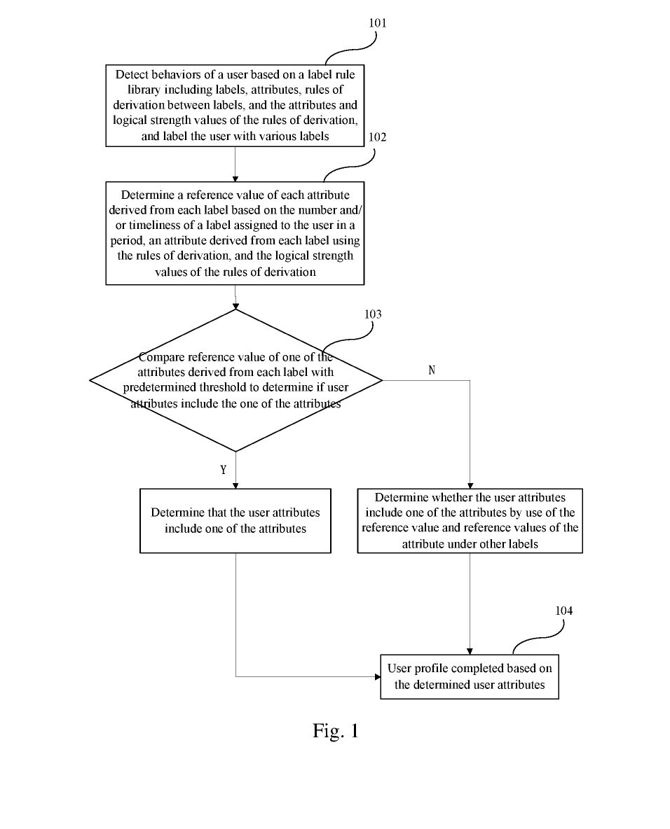

FIG. 1 shows a flow chart of a method for creating individual user profile according to an embodiment of the disclosure. The method includes detecting, by a user profiling server, behaviors of a user based on a label rule library to determine user attributes, which includes the following steps.

Step S101: The user profiling server detects behaviors of a user based on the label rule library, including labels, attributes, rules of derivation between labels and the attributes, and logical strength values of the rules of derivation, and assigns the user with various labels.

Step S102: The user profiling server determines a reference value of each attribute derived from each label based on the number and/or timeliness of a label assigned to the user in a period, an attribute derived from each label using the rules of derivation, and the logical strength values of the rules of derivation.

Step S103: The user profiling server compares the reference value of one of the attributes derived from each label with a predetermined threshold to judge if it can be determined that the user attributes include the one of the attributes. If it cannot be determined, then the user profiling server further judges whether it can be determined that the user attributes include the one of the attributes by use of the reference value as well as reference values of the attribute under other labels.

Step S104: The user profiling server completes to establish a user profile based on the determined user attributes.

Through use of the determination model of the user profile in the user profiling server of the embodiments of the disclosure, differences in user profiles caused by subjective factors of operators are avoided. Thus, not only is collaboration of all labels with one another ensured, but errors an individual user profile are also avoided, which may be caused by noise labels, thereby improving the accuracy of profiling for individual users.

In particular, the step of determining the timeliness of the label may include counting, by the user profiling server, the generation time of a label assigned to the user in a period and determining the timeliness of the label. By using the timeliness of the label as a reference condition of the reference value of the user attributes, the reference values of the user attributes determined by the user profiling server will be more accurate. Further, when comparing the references value of the user attributes with the threshold value to determine the user attributes, the determination of the user attributes will also be more accurate.

As an improvement of the method shown in FIG. 1, after step S104 in FIG. 1, the method further includes: after completing the user profile, pushing, by the user profiling server, personalized information to the user based on the user profile; and detecting, by the user profiling server, behaviors of the user after the user receives the personalized information based on the label rule library, to re-determine the user attribute.

By pushing personalized information to the user via the user profiling server based on the user profile and re-determining the user attribute by the user profiling server based on the user's feedback to the pushed personalized information, calibration of user attributes and user profiles can be realized, and the type of information pushed to the user can be changed based on the user's feedback.

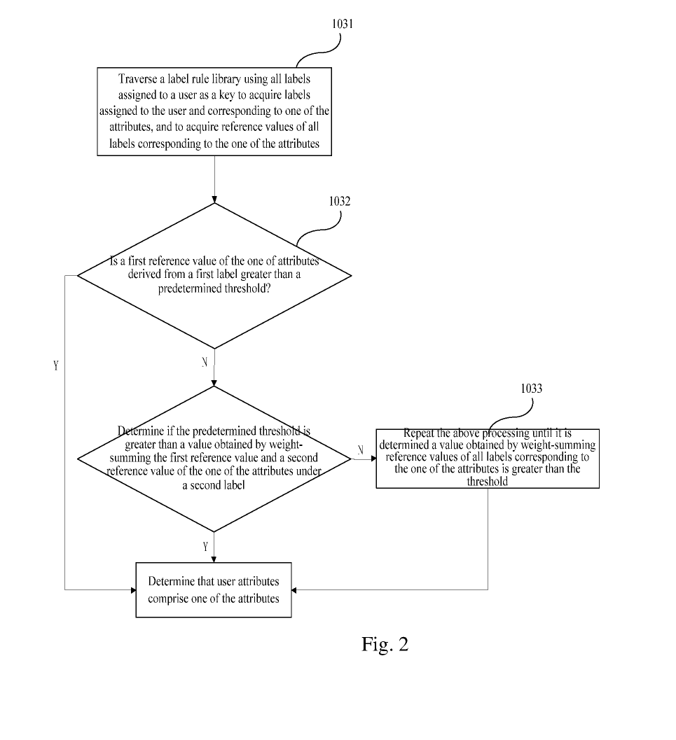

FIG. 2 shows a detailed execution chart of a preferred embodiment of step S103 of the method for creating individual user profile shown in FIG. 1. The step S103 includes the followings steps.

Step S1031: The user profiling server compares a first reference value of one of the attributes derived from a first label with the predetermined threshold. If the first reference value is greater than the predetermined threshold, then it is determined that the user attributes include the one of the attributes. Otherwise, whether the user attributes include the one of the attributes cannot be determined.

Step S1032: The user profiling server compares the predetermined threshold with a value obtained by weight summing the first reference value and a second reference value of the one of the attributes under a second label. If the value obtained by weight summing the first and second reference values is greater than the predetermined threshold, it is determined that the user attributes include the one of the attributes, and if the value obtained by weight summing the first and second reference values is not greater than the predetermined threshold, it cannot be determined that the user attributes include the one of the attributes.

Step S1033: The above processing is repeated until the user profiling server determines that the user attributes include the one of the attributes.

When the user profiling server can determine the user attribute only by derivation of one of labels, there is no necessity to derive and calculate other labels, so that resource consumption of the server in user profiling is reduced. When the user profiling server cannot determine the user attribute only by derivation of one of labels, the user attribute may be derived through a combination with other labels, so that the accuracy of the determined user attribute is improved.

In some alternative embodiments of the disclosure, reference values of all attributes derived from each label are based on logical values, and are proportional to the number and timeliness of labels in a period.

Regarding a specific execution, step S103 may include: comparing, by the user profiling server, a first reference value of one of the attributes derived from a first label with the predetermined threshold. If the first reference value is greater than the threshold, a determination may be made that the user attributes include the one of the attributes, and if the first reference value is not greater than the threshold, it cannot be determined whether the user attributes include the one of the attributes. For example, if the first label is “Cosmetic,” one of the attributes derived from the label “Cosmetic” is female and, if a reference value of the user attribute “Cosmetic,” is greater than the predetermined threshold, it is determined that a user is a female.

If a reference value of a first label corresponding to one of the attributes is smaller than or equal to the threshold, the user profiling server performs weighted iterative summation on all reference values of all labels corresponding to the one of the attributes sequentially. This may be done until a reference iteration value is obtained by weighted iterative summing all of the reference values that are greater than the predetermined threshold, and then the user profiling server may determine the one of the attributes possessed by a user. For example, if a reference value of the label “Cosmetic,” corresponding to female in user gender, is smaller than or equal to the threshold, a label “Skirt,” corresponding to female, is introduced into the user profiling server to be used as a second label, and a reference value of the label “Skirt” corresponding to female is weighted.

For instance, if the weight of the second label of the one of the attributes is set as 0.5, the reference value of the second label “Skirt” of female is multiplied by the second label weight “0.5” to obtain a value, and the obtained value is added with the reference value of “Cosmetic” to obtain an attribute reference superposition value corresponding to female in user gender. Then, the obtained attribute reference superposition value is compared with the predetermined threshold. If the attribute reference superposition value is greater than the predetermined threshold, it is determined that the attribute is female by the first label “Cosmetic” and the second label “Skirt.” If the attribute reference superposition value is smaller than the predetermined threshold, a new label “Youth Idol Drama,” corresponding to female of the user, is introduced into the user profiling server to be used as a third label, and a reference value of the third label “Youth Idol Drama” of female is weighted and added into the attribute reference superposition value.

For example, the weight of the third label of the one of the attributes is set as 0.25, “Youth Idol Drama” is used as the third label of female in user gender, the reference value of female is multiplied by the weight of the third label “0.25” to obtain a value, and the obtained value is added with the attribute reference superposition value to update the attribute reference superposition value. Further, the updated attribute reference superposition value is compared with the predetermined threshold. If the updated attribute reference superposition value is greater than the predetermined threshold, the attribute is determined by the first label “Cosmetic,” the second label “Skirt,” and the third label “Youth Idol Drama,” and the user profiling server determines that the user is a female.

If the updated attribute reference superposition value is smaller than the predetermined threshold, any suitable number N of new labels corresponding to female are introduced to be used as a fourth label, a fifth label, . . . , up to an Nth label, until the weighted summation of reference values of all of the labels is greater than the threshold, in which case it is determined that the user is a female. Meanwhile, the user attribute is derived from the first label, the second label, the third label, the fourth label . . . and the Nth label. In another embodiment of the disclosure, weights of the first label, the second label, the third label, the fourth label, . . . , and the Nth label may each be 1, respectively, and specific derivation processes of other attributes can be referred to the above female derivation process, and will not be repeated herein for purposes of brevity.

As a preferred embodiment of the disclosure, before step S101, the method further includes establishing a label rule library including providing labels, attributes and rules of derivation between labels and the attributes; and setting logical strength values according to weight setting in the rules of derivation between labels and the attributes. The specific execution of establishing the label rule library according to the preferred embodiment may include establishing a label group in a user profiling server, and a derivation rule group including rules of derivation, attributes derived from labels using the rules of derivation, and logical strength values of the rules of derivation in the user profiling server.

It will be understood that the label group may include a plurality of sub-label groups, and different sub-label groups may correspond to attributes at different dimensions. For example, a user age sub-label may correspond to a user age dimension attribute, a user income level sub-label may correspond to a user income level dimension attribute, a user consumption level sub-label may correspond to a user consumption level dimension attribute, a user preference sub-label may correspond to a user preference dimension attribute, and so on. Thus, a user profile may be formed by user attributes in different dimensions.

The derivation rule group may be established in the user profiling server through the following steps. Each label in the label group is interpreted by the user profiling server to obtain matching attributes close to logical interpretations of all of the labels. A logical strength ranging between each label and the matching attribute analyzed and assigned by the user profiling server may be associated with a corresponding logical strength value. Each logical strength value in the derivation rule group is stored by the user profiling server as a derivation rule using each corresponding label and matching attribute as a key.

The user profiling server analyzes the logical strength between each label and the corresponding matching attribute to quantify the logical strength between each label and the matching attribute so as to obtain a quantized value for reflecting the logical strength, and the quantized values are used as the logical strength values and stored in the derivation rule group based on the labels and the matching attributes. Thus, after the label rule library is applied to the user profile, differences in user profiles caused by personal differences are avoided.

It will be understood that labels correspond to user behaviors. When a user performs operations, such as browsing, purchasing, focusing on or collecting products, on web pages corresponding to all data sources, generation of log information is triggered. And accordingly, log information generation times are used for showing times when the user performs the operations, such as browsing, purchasing, paying attention to, or collecting products. For the above user behaviors, product information or product classification information can be selected as labels matched with the user behaviors. For example, if the user often browses digital product websites, a label “Digital” can be correspondingly labeled to the user.

As a variation of the method shown in FIG. 1, step S102 in FIG. 1 may include the following steps.

The user profiling server counts the number of one of the labels assigned to a user for a period;

The user profiling server traverses a label rule library using the above one of the labels as a key to obtain respective rules of derivation including the label, and acquires a reference value of an attribute derived from the label labeled to the user based on the attribute derived from the label using the corresponding derivation rule and a logical strength value of the derivation rule; and

The above processing is repeated so that the user profiling server acquires reference values of attributes derived from respective labels assigned to the user.

In the present embodiment, the number of one label assigned to the user within a period is used as a reference condition for considering label reference values, so that errors to a user profile caused by noise labels are avoided. That is, interference from a label generated by improper operation of a user to the user profile is avoided, so that the user profile accuracy is improved. More specifically, the reference values may be determined through the following sub-steps.

Using the determination of the reference value of a user gender attribute as an illustrative example, the sub-steps may include:

Acquiring, by the user profiling server user, access cache information to determine labels corresponding to the gender attribute, including “Cosmetic,” “Skirt,” and the like generated by a user within 30 days;

inquiring a label rule library, by the user profiling server, based on the acquired user labels to acquire logical strength values of all labels corresponding to the gender attribute, wherein if the label rule library includes rules of derivation, and logical strength values of the rules of derivation are “Cosmetic-Female-7,” and “Skirt-Female-8,” it is determined that a logical strength value of the label “Skirt” corresponding to a female is 8, and a logical strength value of the label “Cosmetic” corresponding to a female is 7;

repeating the above processing so that the user profiling server determines logical strength values of all labels, corresponding to gender, in labels generated by the user;

endowing, by the user profiling server, each label generated by the user with timeliness weight corresponding to timeliness and based on a generation time of each label in the gender attribute (for example, labels generated within 10 days are endowed with the largest timeliness weight of 1, labels generated within 10-20 days are endowed with a general timeliness weight of ½, and labels generated within 20-30 days are endowed with the least timeliness weight of ¼);

endowing the labels with number weights (for example, labels with the number of 1-2 are endowed with the minimum number weight of ¼, labels with the number of 3-10 are endowed with general number weight of ½, and labels with the number of 10 or above are endowed with the maximum number weight of 1); and

determining, by the user profiling sever, a reference value of each label based on the number weight, the timeliness weight and the logical strength value of each label.

As an example, it can be determined that the number weights, the timeliness weights, and the logical strength values of all labels are multiplied to determine reference values of all labels, such as “Cosmetic,” “Skirt,” and the like, in the gender. However, it will be understood that the determination of the reference values is not limited to the multiplication of the number weights, the timeliness weights, and the logical strength values of all labels.

The disclosure further provides a method for creating individual user profile according to a specific embodiment, the method including detecting, by a user profiling server, behaviors of a user and assigning the user with various labels.

For example, the user profiling server may count that label “Digital,” was assigned to a user 5 times within 10 days, inquire the time when each label “Digital” is generated, and determine a timeliness weight of each label “Digital” based on the difference between the generation time and a current time, each label's timeliness weight corresponding to its timeliness.

For example, if the difference between the generation time of the label “Digital” and a current time is smaller than or equal to 2 days, the label “Digital” is endowed with the timeliness weight of 1. If the difference between the generation time of the label “Digital” and a current time is smaller than or equal to 4 days, and greater than 2 days, the label “Digital” is endowed with the timeliness weight of ½. If the difference between the generation time of the label “Digital” and a current time is smaller than or equal to 6 days, and greater than 4 days, the label “Digital” is endowed with the timeliness weight of ¼. In such a manner, the timeliness weight of each label “Digital” is acquired.

The method further includes: traversing, by the user profiling server, a label rule library using the label “Digital” as a key to obtain all rules of derivation including the label, and acquiring by the user profiling server all rules of derivation of the label “Digital” including “Digital-Male-7,” “Digital-Youth-8,” and the like.

It is understood that a reference value of the label “Digital” is related to a timeliness weight of each label “Digital,” the numbers of the label “Digital” at different periods, and a logical strength value of the label “Digital.” For example, the label “Digital” is proportional to the timeliness weight of each label “Digital” and the frequency of the label “Digital” at different periods, and the logical strength value of the label “Digital” can be referred to the logical strength value of the label “Digital” in gender stored in the label rule library, and should be a certain value. Thus, in such a manner, reference values of all attributes of a user within 10 days can be acquired. Moreover, the more detailed acquisition of the reference values can be referred to the above-described embodiments, and its description will not be repeated herein.

The method may further include acquiring, by the user profiling server, all labels corresponding to the user gender attribute, and reference values of the labels. For example, if there are labels “Military,” “Science and Technology Forum,” and the like corresponding to the user gender attribute of a male, reference values of the labels “Military,” “Science and Technology Forum,” and the like are acquired. The method may further include comparing the reference value of a male in user gender derived from “Digital” with a predetermined threshold; determining that gender of a user is male if the reference value corresponding to “Digital” is greater than the predetermined threshold, and determining that the gender of the user is male by referring to a compared result between reference values of the labels “Military,” “Science and Technology Forum,” and the like and the predetermined result, if the reference value corresponding to “Digital” is smaller than the predetermined threshold.

If the reference value of the label “Digital” of a male in user gender is smaller than or equal to the threshold, the method may further include introducing a label “Military” corresponding to male of the user into the user profiling server to be used as a second label, and performing weight summing on a reference value of “Military” corresponding to a male, wherein weights of the first and second labels are different. For example, the weight of the second label of the attribute is set as 0.5, the reference value of the second label “Military” of male is multiplied by the weight “0.5” of the second label to obtain a value, and the obtained value is added with the reference value of “Digital” to obtain an attribute reference superposition value corresponding to male in user gender of the user.

Then, the obtained attribute reference superposition value is compared with the predetermined threshold. If the attribute reference superposition value is greater than the predetermined threshold, it is determined that the attribute is male by the first label “Digital,” and the second label “Military.” If the attribute reference superposition value is smaller than the predetermined threshold, a new label “Science and Technology Forum,” corresponding to a male of the user, is introduced into the user profiling server to be used as a third label.

A reference value of the third label “Science and Technology Forum,” corresponding to a male, is weighted and added into the attribute reference superposition value, and a weight of the third label “Science and Technology Forum,” is different from that of each of the first and second labels. For example, the weight of the third label of the attribute is set as 0.25, “Science and Technology Forum” is used as the third label of male in user gender, the reference value of male is multiplied by the weight of the third label “0.25” to obtain a value, and the obtained value is added with the attribute reference superposition value to update the attribute reference superposition value of the male attribute in user gender.

Further, the updated attribute reference superposition value is compared with the predetermined threshold. If the updated attribute reference superposition value is greater than the predetermined threshold, the attribute is determined by the first label “Digital,” the second label “Military,” and the third label “Science and Technology Forum,” and moreover, it is determined that the user is a male. If the updated attribute reference superposition value is still smaller than the predetermined threshold, any suitable number N of new labels corresponding to male are introduced to be used as a fourth label, a fifth label, . . . up to an Nth label by the same manner, and it is determined that the user is a male until the weighted summation of reference values of all of the labels is greater than the threshold. Meanwhile, the user attribute is derived from the first label, the second label, the third label, the fourth label . . . and the Nth label.

In the above manner, the user profiling server may count user attributes of a user in different dimensions. As an example, the consumption level and the education level, bachelor degree (or above or below), of the user are counted. In this way, the user profiling server draws a user profile based on the user attributes of the user in different dimensions.

In one embodiment, if the sum of reference values of all labels of one attribute is smaller than a predetermined threshold, the user profiling server calculates and derives the labels of the attribute via a user attribute mining model to obtain the attributes. Common user attribute mining models may include, for example, an SVM model, a Bayesian model, a clustering model, a weight-averaging model, etc.

In some alternative embodiments of the disclosure, the determination of the above predetermination threshold may be derived based on experiments or experience. For example, after several experiments, it can be derived that if a reference value of the label “Digital” is greater than an experimental value, the user gender attribute can be determined as male. If the reference value of the label “Digital” is smaller than or equal to the experimental value, whether the user gender attribute is male cannot be determined. Therefore, the experimental value is set as the threshold.

The specific embodiments of the disclosure provide an attribute derivation method via labeling to avoid differences in a user profile caused by personal differences of operators. Thus, not only is the combined effect ensured, but also errors to the user profile caused by noise labels are avoided. Moreover, the user profiling accuracy is ensured by periodically re-determining attribute values of user labels to further change the type of pushed personalized information.

The disclosure provides a scheme for accurately acquiring a user profile, mainly including the following steps. First, a label rule library is established in a user profiling server, the label rule library including rules (for example, if a user usually browses cosmetics websites, the user is labeled to a label “Cosmetics”; and accordingly, it may be derived that the user gender is female; and if a user behavior corresponds to a variety of brands of milk powder, the user is labeled to another label “Milk Powder”; and accordingly, it may be derived that the user age is middle) between user behaviors and user labels. It should be noted that although the rules of derivation may not be entirely accurate, they are logical, and logical strength values of the rules of derivation are set based on the logical weights of the rules of derivation. Then, each user is labeled with various labels based on behaviors of each user. Any user may be repeatedly labeled with one of the labels. Meanwhile, the newer the label is, the better the timeliness thereof is. The method also includes counting the number of each label assigned to the user based on user cache; deriving and calculating an attribute reference value of each label in one of the attributes based on the timeliness and the logical strength values; and finally, determining the one of the attributes when the attribute reference value is greater than a predetermined value, or determining the one of the attributes by a plurality of labels together if the attribute reference value is smaller than or equal to the predetermined value.

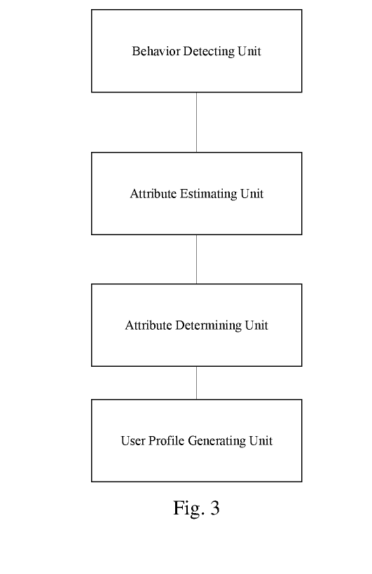

FIG. 3 is a schematic view showing a structure of a system for creating individual user profile according to an embodiment of the disclosure. The system may include, for example:

a behavior detecting unit configured to detect behaviors of a user based on a label rule library including labels, attributes, rules of derivation between labels and the attributes, and logical strength values of the rules of derivation, and to label the user with various labels;

an attribute estimating unit configured to determine a reference value of each attribute derived from each label based on the number of a label assigned to the user by the behavior detecting unit in a period, an attribute derived from each label using the rules of derivation, and the logical strength values of the rules of derivation;

an attribute determining unit configured to compare the reference value of one of the attributes derived from each label by the attribute estimating unit with a predetermined threshold to determine if the user attributes include the one of the attributes, wherein if the user attributes do not include the one of the attributes, then it can be judged whether it can be determined that the user attributes include the one of the attributes by use of the reference value as well as reference values of the attribute under other labels; and

a user profile generating unit configured to complete a user profile based on the user attributes determined by the attribute determining unit.

By applying an individual user profile determination model to the embodiments of the disclosure, differences in user profiles caused by subjective factors are avoided, and each of the labels can collaborate with one another, errors to an individual user profile caused by noise labels are avoided, and the individual user profiling accuracy is improved.

The system for creating individual user profile in the present embodiment may be implemented, for example, as a server or a server cluster, wherein each unit may be a separate server or server cluster. Thus, interaction among the above units in such a case is that among the servers or the server clusters corresponding to all units, and the plurality of servers or server clusters may constitute the system for creating individual user profile provided by the disclosure.

For example, the system for creating individual user profile formed by the plurality of servers or server clusters may include:

a behavior detecting server or server cluster configured to detect behaviors of a user based on a label rule library including labels, attributes, rules of derivation between labels and the attributes, and logical strength values of the rules of derivation, and to label the user with various labels;

an attribute estimating server or server cluster configured to determine a reference value of each attribute derived from each label based on a number of a label assigned to the user by the behavior detecting server or server cluster in a period, an attribute derived from each label using the rules of derivation, and the logical strength values of the rules of derivation;

an attribute determining server or server cluster configured to compare the reference value of one of the attributes derived from each label by the attribute estimating server or server cluster with a predetermined threshold to judge whether it can be determined that the user attributes include the one of the attributes and, if not, it is judged whether it can be determined that the user attributes include the one of the attributes by use of the reference value as well as reference values of the attribute under other labels; and

a user profile generating server or server cluster configured to complete a user profile based on the user attributes determined by the attribute determining server or server cluster.

In one alternative embodiment, several units in the above multiple units may together form a server or server cluster. For example, the behavior detecting unit and the attribute estimating unit together may constitute a first server or a first server cluster, the attribute determining unit may form a second server or a second server cluster, and the user profile generating unit may constitutes a third server or a third server cluster.

Here, interactions among the above units are that among the first to third servers or the first to third server clusters, and the first, second, and third servers or the first, second and third server clusters constitute the system for creating individual user profile provided by the disclosure.

As a variation of the system shown in FIG. 3, the attribute determining unit may include, for example:

a first label attribute determining module configured to compare a first reference value of one of the attributes derived from a first label with the predetermined threshold, wherein if the first reference value is greater than the predetermined threshold, it is determined that the user attributes include the one of the attributes, and if the first reference value is not greater than the predetermined threshold, it cannot be determined that the user attributes include the one of the attributes; and

an additional label attribute determining module configured to compare the predetermined threshold with a value obtained by weight summing the first reference value derived from the first label attribute determining module and a second reference value of the one of the attributes under a second label, wherein if the value obtained by weight summing the first and second reference values is greater than the predetermined threshold, it is determined that the user attributes include the one of the attributes, and if the value obtained by weight-summing the first and second reference values is not greater than the predetermined threshold, it cannot be determined that the user attributes include the one of the attributes, and the above procedures are repeated until it can be determined that the user attributes include the one of the attributes.

The attribute determining unit in the present embodiment may be implemented, for example, as a server or a server cluster, wherein each module may be a separate server or server cluster. Thus, interaction between the above modules in such a case is that between the servers or the server clusters corresponding to all modules, and the plurality of servers or server clusters together may form the attribute determining unit to constitute the system for creating individual user profile provided by the disclosure.

In one alternative embodiment, several modules in the above multiple modules together form a server or server cluster.

In the present embodiment, when the user attribute can be determined by derivation of one of the labels, it is not necessary to derive and calculate other labels, so that resource consumption of the server in user profiling is reduced. When the user attribute cannot be determined by derivation of only one of labels, the user attribute can be derived in combination with other labels, so that the accuracy of the determined user attribute is improved.

As an improvement of the system shown in FIG. 3, the system may further include a label rule library establishing unit connected with the behavior detecting unit and configured to provide labels, attributes, and rules of derivation between labels and the attributes, and set logical strength values based on the weights of the rules of derivation between labels and the attributes, to enable the behavior detecting unit to detect user behaviors based on the rules of derivation determined by the label rule library establishing unit so as to label a user with various labels.

More specifically, the label rule library establishing unit includes:

a label group establishing module configured to establish a label group; and

a derivation rule group establishing module configured to establish a derivation rule group including the rules of derivation, attributes derived from labels in the label group established by the label group establishing module by use of the rules of derivation, and logical strength values of the rules of derivation; establishing the derivation rule group including: interpreting each label in the label group established by the label group establishing module to obtain matching attributes close to logical interpretations of the labels; analyzing the logical strength between each label and the matching attribute, and endowing the logical strength between each label and the matching attribute with a corresponding logical strength value; and storing each logical strength value in the derivation rule group as a derivation rule by using each label and the corresponding matching attribute as a key.

The label rule library establishing module in the present embodiment may be implemented, for example, as a server or a server cluster, wherein each module may be a separate server or server cluster. Thus, interaction among the above modules in such a case is that among the servers or the server clusters corresponding to all modules, and the plurality of servers or server clusters together form the label rule library establishing module to constitute the system for creating individual user profile provided by the disclosure.

In one alternative embodiment, several modules in the above multiple modules together form a server or server cluster.

In the present embodiment, the logical strength between each label and the matching attribute is quantified by analyzing the logical strength between each label and the matching attribute to obtain a quantized value for reflecting the logical strength, and the quantized values are used as the logical strength values and stored in the derivation rule group based on the labels and the matching attributes. Thus, after the established label rule library is applied to the user profile, differences in user profiles caused by personal differences are avoided.

As a variation of the system shown in FIG. 3, an information pushing unit is further connected with the user profile generating unit, and configured to, after completing the user profile, push personalized information to the user based on the user profile generated by the user profile generating unit, and detect behaviors of the user after the user receives the personalized information based on the label rule library to re-determine the user attribute.

Each of the information pushing unit and the user profile generating unit in the embodiments may be implemented, for example, as a server or a server cluster. Thus, interactions between the user profile generating unit and the information pushing unit in such a case are implemented between the servers or the server clusters corresponding to the units, and the server or server cluster forms the information pushing unit to constitute the system for creating individual user profile provided by the disclosure.

In the present embodiment, the personalized information is pushed to the user based on the user profile, and user attributes are re-determined based on the user's feedback to the pushed personalized information, so that calibration of the user attribute and the user profile is realized, and the type of information pushed to the user can be changed based on the user's feedback.

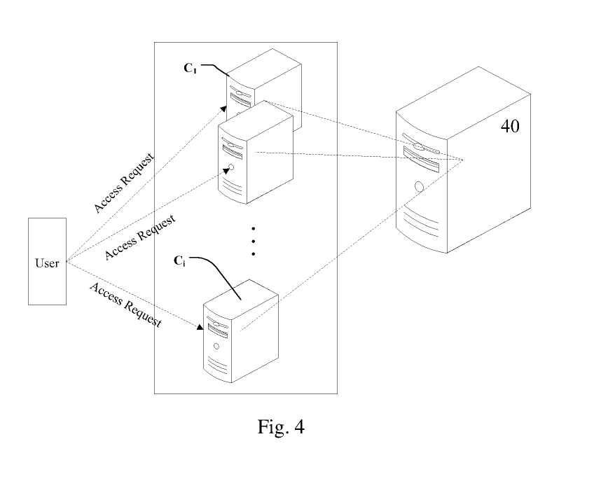

FIG. 4 shows architecture for implementing the method and system for creating individual user profile according to embodiments of the disclosure. The architecture includes a user profiling server 40 and any suitable number i of access servers C1 to Ci. In the architecture, after the access servers C1 to Ci complete response to access requests sent by a user via a client (e.g., a smart terminal), the user profiling server 40 carries out the method for creating individual user profile shown in FIG. 1 based on cache information of the server access requests in the access servers C1 to Ci to acquire a relatively accurate user profile.

An embodiment of the present application provides a non-transitory computer-readable storage medium storing executable instructions that, when executed by one or more processors associated with an electronic device, cause the electronic device to execute the method for creating individual user profile mentioned above.

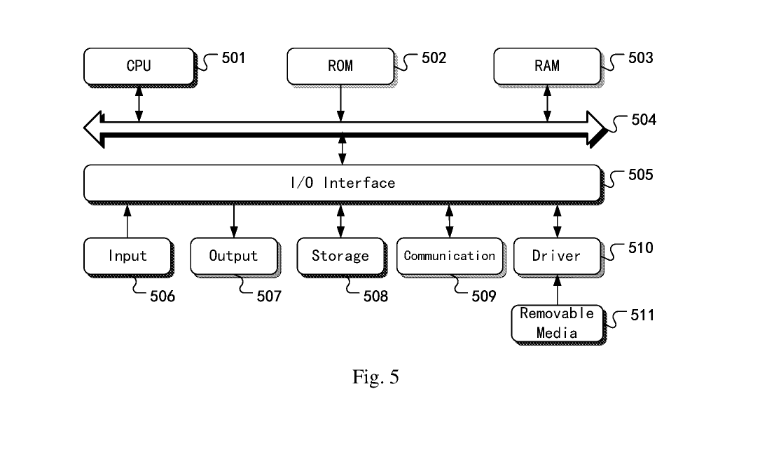

FIG. 5 is a schematic view showing an electronic device or server for realizing the embodiments of the disclosure. The device may include, for example, a processor such as a central processing unit (CPU) 501, which can perform various appropriate actions and processing according to a program stored in a read-only memory (ROM) 502 or a program loaded to a random access memory (RAM) 503 from a storage part 508. Various programs and/or data required during operation of the system may also be stored in the RAM 503. CPU 501, ROM 502 and/or RAM 503 may be connected with one another via a bus 504. An Input/output (I/O) interface 505 may also be connected to bus 504.

Components connected to the Input/output (I/O) interface 505 may include, for example, an input part 506 including a keyboard, user input device (e.g., a mouse and the like), an output part 507 such as, for example, a cathode ray tube (CRT), a liquid crystal display (LCD) and the like, a storage part 508 including, for example, a hard disk and the like, and a communication part 509 of network interface cards including, for example, an LAN card, a modem, etc. The communication part 509 may perform communication processing via a network such as the Internet. A driver 510 may be connected to the Input/output (I/O) interface 505 as required to facilitate proper operation. A removable medium 511 such as a magnetic disk, an optical disk, a magneto-optical disk, and/or a semiconductor memory may also be installed on the driver 510 as needed to enable a computer program to read out from the removable medium to be installed into the storage part 508 accordingly.

Particularly, according to the embodiments of the disclosure, the steps described in the above reference flow charts may be implemented as a computer program. For example, the embodiments of the disclosure may include a computer program product including a computer program which is tangibly contained in a machine-readable medium, and the computer program may include a program code for performing the method as shown in the flow chart. In such embodiments, the computer program may be downloaded and installed from the network via the communication part 509, and/or may be installed from the removable medium 511.

In one aspect of application of the disclosure, the system for creating individual user profile provided by the embodiments of the disclosure may be embedded in a website server as a functional element. In another aspect of application of the disclosure, the system for creating individual user profile provided by the embodiments of the disclosure may be also embedded in a cloud server connected between the website server and a user terminal.

Embodiments of the present application and the technical features involved therein may be combined with each other as long as this is done in a compatible manner. Furthermore, terms such as “include,” “including,” and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article, or device including said elements of other equivalent elements.

The relevant functional modules or units may be implemented through hardware such as a processor, in various embodiments of the invention.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that the above embodiments are provided to describe the technical solutions of the present application, but are not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

What is claimed is:

1. A method for creating individual user profile, applied to an electronic device, to detect behaviors of a user based on a label rule library including labels, attributes, rules of derivation between labels and the attributes, and logical strength values of the rules of derivation to determine user attributes, the method comprising:
detecting the behaviors of the user and labeling the user with various labels;
determining a reference value of each attribute derived from each label based on the number and/or timeliness of a label assigned to the user in a period, an attribute derived from each label using the rules of derivation and the logical strength values of the rules of derivation;
comparing the reference value of one of the attributes derived from each label with a predetermined threshold to judge if it can be determined that the user attributes comprise the one of the attributes and, if not, then is it judged whether it can be determined that the user attributes comprise the one of the attributes by use of the reference value as well as reference values of the attribute under other labels; and
completing the user profile based on the determined user attributes.

2. The method of claim 1, wherein the act of comparing the reference value of one of the attributes derived from each label with the predetermined threshold to judge if it can be determined that the user attributes comprise the one of the attributes comprises:
comparing a first reference value of one of the attributes derived from a first label with the predetermined threshold,
wherein if the first reference value is greater than the predetermined threshold, it is determined that the user attributes comprise the one of the attributes, and if the first reference value is not greater than the predetermined threshold, it cannot be determined that the user attributes comprise the one of the attributes;
comparing the predetermined threshold with a value obtained by weight-summing the first reference value and a second reference value of the one of the attributes under a second label when it is determined that the user attributes do not comprise the one of the attributes based on the first reference value,
wherein if the value obtained by weight-summing the first and second reference values is greater than the predetermined threshold, it is determined that the user attributes comprise the one of the attributes, and if the value obtained by weight-summing the first and second reference values is not greater than the predetermined threshold, it cannot be determined that the user attributes comprise the one of the attributes; and
repeating the above processing until it is determined that the user attributes comprise the one of the attributes.

3. The method of claim 1, further comprising:
after the user profile is completed, pushing personalized information to the user based on the user profile; and
detecting behaviors of the user after the user receives the personalized information based on the label rule library to re-determine the user attribute.

4. The method of claim 1, further comprising:
before detecting the behaviors of the user based on the label rule library, establishing the label rule library,
wherein establishing the label rule library comprises:
providing the labels, the attributes, and the rules of derivation rules of derivation between labels and the attributes; and
setting the logical strength values based on the weights of the rules of derivation rules of derivation between labels and the attributes.

5. An electronic device, comprising:
at least one processor; and
a memory communicably connected with the at least one processor configured to store instructions executable by the at least one processor, wherein execution of the instructions by the at least one processor causes the at least one processor to:
detect behaviors of a user based on a label rule library including labels, attributes, rules of derivation rules of derivation between labels and the attributes, and logical strength values of the rules of derivation, and to label the user with various labels;
determine a reference value of each attribute derived from each label based on the number or timeliness of a label assigned to the user in a period, an attribute derived from each label using the rules of derivation, and the logical strength values of the rules of derivation;
compare the reference value of one of the attributes derived from each label with a predetermined threshold to judge whether it can be determined that the user attributes comprise the one of the attributes and, if not, it is judged whether it can be determined that the user attributes comprise the one of the attributes by use of the reference value as well as reference values of the attribute under other labels; and
complete a user profile based on the determined user attributes.

6. The electronic device of claim 5, wherein execution of the instructions by the at least one processor further causes the at least one processor to:
compare a first reference value of one of the attributes derived from a first label with the predetermined threshold,
wherein if the first reference value is greater than the predetermined threshold, it is determined that the user attributes comprise the one of the attributes, and if the first reference value is not greater than the predetermined threshold, it cannot be determined that the user attributes comprise the one of the attributes;
compare the predetermined threshold with a value obtained by weight-summing the first reference value and a second reference value of the one of the attributes under a second label when it cannot be determined that the user attributes comprise the one of the attributes based on the first reference value,
wherein if the value obtained by weight-summing the first and second reference values is greater than the predetermined threshold, then it is determined that the user attributes comprise the one of the attributes, and if the value obtained by weight-summing the first and second reference values is not greater than the predetermined threshold, it cannot be determined that the user attributes comprise the one of the attributes; and
repeat the above processing until it is determined that the user attributes comprise the one of the attributes.

7. The electronic device of claim 5, wherein execution of the instructions by the at least one processor further causes the at least one processor to, after the user profile is completed, push personalized information to the user based on the user profile, and
wherein execution of the instructions by the at least one processor further causes the at least one processor to detect behaviors of the user after the user receives the personalized information based on the label rule library to re-determine the user attribute.

8. The electronic device of claim 5, wherein execution of the instructions by the at least one processor further causes the at least one processor to:
provide the labels, the attributes, and the rules of derivation between labels and the attributes; and
set the logical strength values based on the weights of the rules of derivation between labels and the attributes.

9. A non-transitory computer-readable storage medium storing executable instructions that, when executed by one or more processors associated with the electronic device, cause the electronic device to:
detect behaviors of a user based on a label rule library including labels, attributes, rules of derivation rules of derivation between labels and the attributes, and logical strength values of the rules of derivation, and to label the user with various labels;
determine a reference value of each attribute derived from each label based on the number and/or timeliness of a label assigned to the user in a period, an attribute derived from each label using the rules of derivation and the logical strength values of the rules of derivation;
compare the reference value of one of the attributes derived from each label with a predetermined threshold to determine if the user attributes comprise the one of the attributes and, if not, it is judged whether it can be determined that the user attributes comprise the one of the attributes by use of the reference value as well as reference values of the attribute under other labels; and
complete a user profile based on the determined user attributes.

10. The non-transitory computer-readable storage medium of claim 9, wherein execution of the instructions by the electronic device further causes the electronic device to:
compare a first reference value of one of the attributes derived from a first label with the predetermined threshold,
wherein if the first reference value is greater than the predetermined threshold, it is determined that the user attributes comprise the one of the attributes, and if the first reference value is not greater than the predetermined threshold, it cannot be determined that the user attributes comprise the one of the attributes;
compare the predetermined threshold with a value obtained by weight-summing the first reference value and a second reference value of the one of the attributes under a second label if cannot be determined that the user attributes comprise the one of the attributes based on the first reference value,
wherein if the value obtained by weight-summing the first and second reference values is greater than the predetermined threshold, then it is determined that the user attributes comprise the one of the attributes, and if the value obtained by weight-summing the first and second reference values is not greater than the predetermined threshold, it cannot be determined that the user attributes comprise the one of the attributes; and
repeat the above processing until it is determined that the user attributes comprise the one of the attributes.

11. The non-transitory computer-readable storage medium of claim 9, wherein execution of the instructions by the electronic device further causes the electronic device to, after the user profile is completed, push personalized information to the user based on the user profile, and
wherein execution of the instructions by the electronic device further causes the electronic device to detect behaviors of the user after the user receives the personalized information based on the label rule library to re-determine the user attribute.

12. The non-transitory computer-readable storage medium of claim 9, wherein execution of the instructions by the electronic device further causes the electronic device to:
provide the labels, the attributes, and the rules of derivation between labels and the attributes; and
set the logical strength values based on the weights of the rules of derivation between labels and the attributes.
